(19) United States
(12) Patent Application Publication
(10) Pub. No.: US 2008/0235944 A1
(43) Pub. Date: Oct. 2, 2008

(54) METHOD OF MAKING A CORRUGATED ELECTRODE CORE TERMINAL INTERFACE

(76) Inventor: John Miller, Cedar, MI (US)

Correspondence Address: MAXWELL TECHNOLOGIES, INC., 9244 BALBOA AVENUE, SAN DIEGO, CA, 92123, US

(21) Appl. No.: 11/694,995

(22) Filed: Mar. 31, 2007

(51) Int. Cl. H01R 43/04; H01R 43/00; B23P 19/00

(52) U.S. Cl. 29/857; 29/882; 29/869; 29/749

(57) ABSTRACT

A method of making a corrugated electrode core terminal interface is disclosed.

### BACKGROUND

1. Field

The disclosed apparatuses and article of manufacture relates generally to energy storage devices, and particularly to effectively reducing an overall size of such an energy storage device.

2. Related Art

Electrodes are widely used in many devices that store electrical energy, including primary (non-rechargeable) battery cells, secondary (rechargeable) battery cells, fuel cells, and capacitors. Important characteristics of electrical energy storage devices include energy density, power density, maximum charging rate, internal leakage current, equivalent series resistance (ESR), and durability, i.e., the ability to withstand multiple charge-discharge cycles. For a number of reasons, double layer capacitors, also known as supercapacitors and ultracapacitors, are gaining popularity in many energy storage applications. The reasons include availability of double layer capacitors with high power densities (in both charge and discharge modes), and with energy densities approaching those of conventional rechargeable cells.

Double layer capacitors use electrodes immersed in an electrolyte (an electrolytic solution) as their energy storage element. Typically, a porous separator immersed in and impregnated with the electrolyte ensures that the electrodes do not come in contact with each other, preventing electronic current flow directly between the electrodes. At the same time, the porous separator allows ionic currents to flow between the electrodes in both directions. As discussed below, double layers of charges are formed at the interfaces between the solid electrodes and the electrolyte. Double layer capacitors owe their descriptive name to these layers.

When electric potential is applied between a pair of electrodes of a double layer capacitor, ions that exist within the electrolyte are attracted to the surfaces of the oppositely-charged electrodes, and migrate towards the electrodes. A layer of oppositely-charged ions is thus created and maintained near each electrode surface. Electrical energy is stored in the charge separation layers between these ionic layers and the charge layers of the corresponding electrode surfaces. In fact, the charge separation layers behave essentially as electrostatic capacitors. Electrostatic energy can also be stored in the double layer capacitors through orientation and alignment of molecules of the electrolytic solution under influence of the electric field induced by the potential.

In comparison to conventional capacitors, double layer capacitors have high capacitance in relation to their volume and weight. There are two main reasons for these volumetric and weight efficiencies. First, the charge separation layers are very narrow. Their widths are typically on the order of nanometers. Second, the electrodes can be made from a porous material, having very large effective surface area per unit volume. Because capacitance is directly proportional to the electrode area and inversely proportional to the widths of the charge separation layers, the combined effects of the large effective surface area and narrow charge separation layers result in capacitance that is very high in comparison to that of conventional capacitors of similar size and weight. High capacitance of double layer capacitors allows the capacitors to receive, store, and release large amounts of electrical energy.

Achieving higher energy densities, for storage of greater amounts of energy, and decreasing cell size, to improve portability are two parameters which drive energy storage device design today. Many modern energy storage device electrode cores employ a “jelly-roll” technique for circumferentially winding a relatively planar electrode core about a longitudinal axis in order to increase energy storage surface area.

One design issue with energy storage devices is energy storage capacity scalability with reduction in overall cell size. When manufacturing energy storage device cells smaller than “C-cell” size, cost effectiveness becomes a problem, because as the overall cell size is decreased, the ratio of active material to total material trends to zero. That is, as the overall cell size of an energy storage device is scaled down, a ratio of active materials verses total materials of the device tends toward zero. There is a necessary “overhead” of inactive materials needed for the device, such as terminations, current collectors, and packaging that does not scale proportionally with overall cell size reduction. Active materials, on the other hand, do scale proportionally with a reduction in overall cell size.

Therefore, a need exists to improve cost effectiveness in energy storage device cells smaller than “C-cell” size. The present teachings provide solutions for the aforementioned issues.

### BRIEF DESCRIPTION OF THE DRAWINGS

Embodiments of the disclosed method and apparatus will be more readily understood by reference to the following figures, in which like reference numbers and designations indicate like elements.

FIG. 1 illustrates an unfolded electrode assembly, according to one embodiment of the present teachings.

FIG. 2 illustrates an assembled energy storage device, according to one embodiment of the present teachings.

FIG. 3 illustrates wire terminals wrapping around a terminal post, according to one embodiment of the present teachings.

FIG. 4 illustrates a rolled connection, according to one embodiment of the present disclosure.

FIG. 5 illustrates a crimped connection, according to one embodiment of the present teachings.

FIG. 6 illustrates an insertion of collected terminal wires into a barrel terminal, according to one embodiment of the present teachings.

FIG. 7 illustrates a method of making a corrugated electrode core terminal interface, according to one embodiment of the present teachings.

### DETAILED DESCRIPTION

### Overview

The presently disclosure teaches of a corrugated electrode core terminal interface apparatus and method for making the same, which provides a cost-effective means for reducing an overall size of an energy storage device, such as for example an ultracapacitor or a battery, when such devices are scaled below “C-cell” size. In one embodiment, such cost effectiveness with scaling is made possible, because the present teachings eliminate the prior art need for excess foil overhang in an electrode element, which the prior art has used to crimp or weld the electrode element to a terminal.

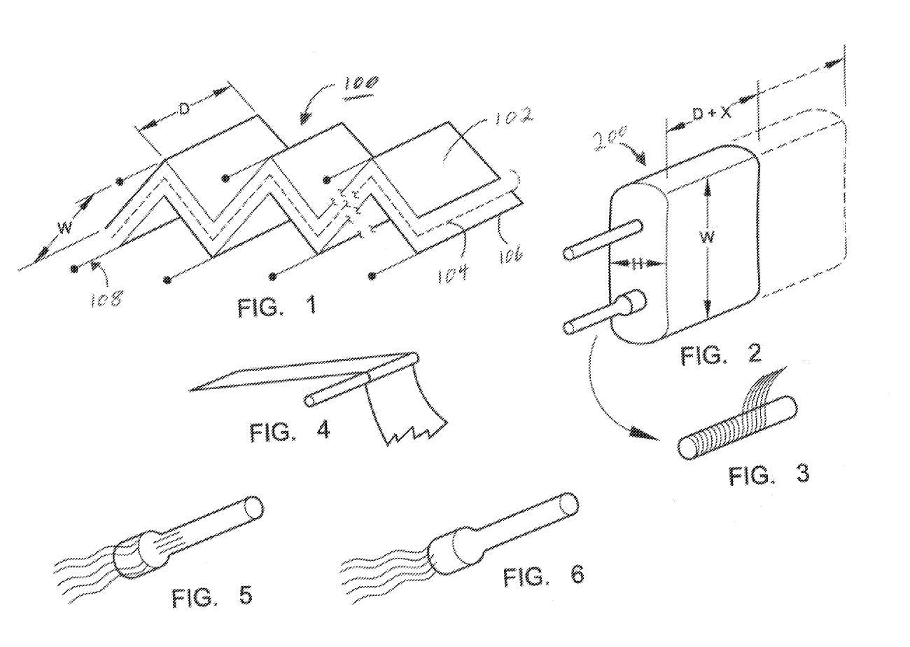

FIG. 1 illustrates one embodiment of a corrugated electrode core terminal interface apparatus 100 of the present teachings. In the illustrative embodiment, the corrugated electrode core terminal interface apparatus 100 comprises a first current collector foil member 102, a separator element 104, a second current collector foil member 106, and a plurality of termination wires 108. The first current collector foil member 102 has a top side and a bottom side. The bottom side of the first current collector foil member 102 is operatively coupled to a first side of the separator element 104. A second side of the separator element 104 is operatively coupled to a top side of the second current collector foil member 106. The corrugated electrode core terminal interface apparatus 100 further comprises a plurality of termination wires 108, wherein a proximate end of each one of the plurality of termination wires 108 is operatively connected to the collector current foil member 102, and wherein a distal end of each one of the plurality of termination wires 108 extends approximately orthogonally outward from the corrugated electrode core terminal interface apparatus. In one embodiment, the plurality of termination wires 108 is made of a conductor, such as for example aluminum. When folded together as shown in FIG. 1, and then compressed, the corrugated electrode core terminal interface apparatus 100 comprises an electrode brick, as illustrated in FIG. 2, which is useful when functionally employed in an energy storage device, such as for example in an ultracapacitor or a lithium ion battery.

In one embodiment, the current collector foil members 102 and 106 further comprise an activated element, such as for example carbon. The reader is directed to U.S. Pat. Nos. 6,451,073, 6,059,847, 7,102,877 for general background on the use of activated carbon on a current collector foil.

In one embodiment, there is no “overhang” with respect to either the first current collector foil member 102, the separator element 104, or the second current collector foil member 106. That is, lateral and lengthwise dimensions of the first current collector foil member 102, the separator element 104, and the second current collector foil member 106 are approximately identical. In prior art solutions, a collector foil(s) had a “wider” lateral dimension than a separator, thereby creating an “overhang”. The extra lateral portion(s) of the “wider” collector foil(s) have been attached to a terminal or collector by an affixing means, such as for example welding by creating the “overhang” of the current collector foil(s) to a terminal or current collector. The “overhang” reduces cost-effectiveness of an energy storage device cell, as will be appreciated by those of ordinary skill in the art. The present disclosure is useful to eliminate such an overhang, thereby improving the cost effectiveness of scaling an energy storage device, such as for example an ultracapacitor or lithium ion battery, to below C-cell sizes. Moreover, the preset teachings circumvent the need for a fixed portion of inactive material by integrating in the plurality of termination wires to current collector foils. The aforementioned eliminates the need for excess foil overhand for which the prior art has relied upon to crimp or weld thereto for conduction between the electrode and the terminal.

The prior art has employed “jelly roll” electrode architectures for electrode construction. The present teachings change, by contrast break the jelly roll paradigm by using a corrugated style of electrode assembly pair for packing into a cell package, such as for example a prismatic cell package.

In one embodiment, the plurality of termination wires 108 are positioned at fold seams of the current collector foils 102 and/or 106 as shown in FIG. 4, and naturally collect into groups of bundles when the assembly is compressed, accordion style, into an electrode brick, as shown in FIG. 2. The plurality of termination wires 108 groups are then inserted into a connector, such as for example a barrel connector as shown in FIG. 6, wherein the plurality of termination wires 108 are then crimped or soldered as shown in FIG. 5, and then mated to the cell package. The plurality of termination wires 108 can also be ultrasonic welded to the current collector foil member 102 along the full width of the foil 102.

Prior art solutions, implementing the “jelly roll” manufacturing process scales to large cells better than sub-C cells. The present teachings help eliminate the need for direct foil to can and lid welding which require considerable axially length in the package to accommodate.

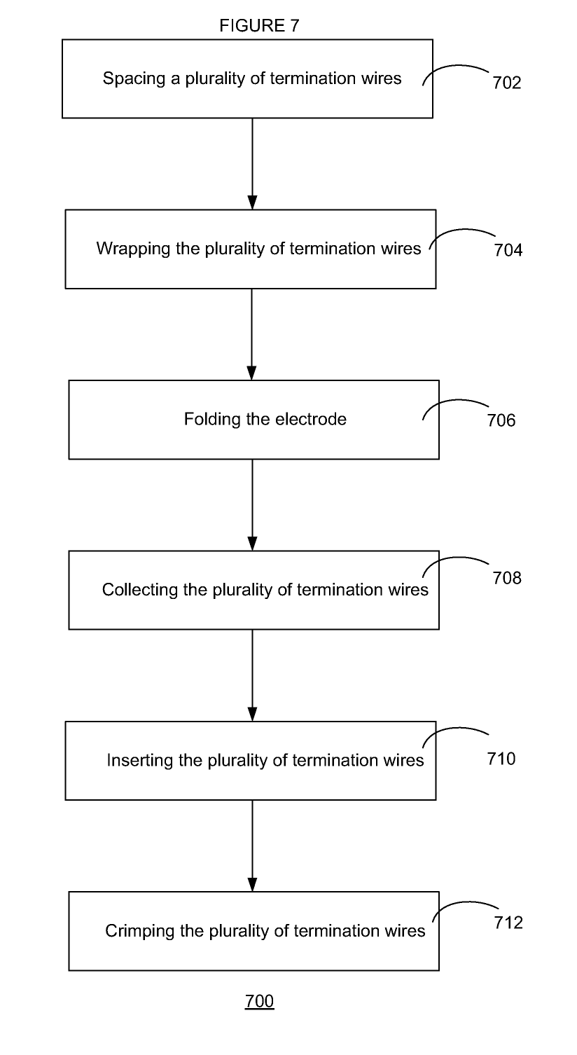

As illustrated in FIG. 7, in one embodiment, a method 700 for making a corrugated electrode core terminal interface apparatus is disclosed. In a first STEP 702, of spacing a plurality of termination wires along fold areas of the current collector foils is performed. In a next STEP 704 of wrapping the plurality of termination wires, each one of the plurality of termination wires are individually wrapped (e.g., rolled) within the current collector foil fold lines, such that a mechanical connection is established between the plurality of termination wires and the current collector foil. In a next STEP 706, of folding the electrode, the corrugated electrode is folded along collector foil fold lines and the plurality of termination wires naturally group together. In a next STEP 708, of collecting the plurality of termination wires, at least two groups of wires are grouped together into at least two bundles. In a next STEP 710, of inserting the plurality of termination wires, the at least two bundles are inserted into barrel terminations. In a final STEP 712, of crimping, the bundled plurality of termination wires are crimped, or otherwise mechanically affixed to leads, such as for example barrel leads, such as those illustrated in FIGS. 5 and 6.

According to the present teachings, the entire corrugated electrode surface along the electrode width (W) is active. In some embodiment, there still may be some separator element 104 overhang.

The present teachings provide a high pulse power capability for sub-C cells, and also facilitates improved power cell ratings. The present teachings are adaptable for low capacity, but high pulse power applications such as automotive power net stabilization and high power load distributed module use.

### Conclusion

The foregoing description illustrates exemplary implementations, and novel features, of aspects of an method of making for effectively providing an energy storage electrode core. Given the wide scope of potential applications, and the flexibility inherent in electro-mechanical design, it is impractical to list all alternative implementations of the method and apparatus. Therefore, the scope of the presented disclosure should be determined only by reference to the appended claims, and is not limited by features illustrated or described herein except insofar as such limitation is recited in an appended claim.

While the above description has pointed out novel features of the present teachings as applied to various embodiments, the skilled person will understand that various omissions, substitutions, permutations, and changes in the form and details of the methods and apparatus illustrated may be made without departing from the scope of the disclosure. These and other variations constitute embodiments of the described methods and apparatus.

Each practical and novel combination of the elements and alternatives described hereinabove, and each practical combination of equivalents to such elements, is contemplated as an embodiment of the present disclosure. Because many more element combinations are contemplated as embodiments of the disclosure than can reasonably be explicitly enumerated herein, the scope of the disclosure is properly defined by the appended claims rather than by the foregoing description. All variations coming within the meaning and range of equivalency of the various claim elements are embraced within the scope of the corresponding claim. Each claim set forth below is intended to encompass any system or method that differs only insubstantially from the literal language of such claim, as long as such apparatus or method is not, in fact, an embodiment of the prior art. To this end, each described element in each claim should be construed as broadly as possible, and moreover should be understood to encompass any equivalent to such element insofar as possible without also encompassing the prior art.

1. A method of making a corrugated electrode core terminal interface, comprising:
(a.) spacing a plurality of termination wires along fold areas of a current collector foil;
(b.) wrapping the plurality of termination wires within the current collector foil;
(c.) folding the current collector foil along collector foil fold lines;
(d.) collecting the plurality of termination wires, whereby at least two groups of termination wires are thereby bundled together;
(e.) inserting the at least two groups of bundled termination wires into at least two barrel termination leads, and;
(f.) crimping the barrel termination leads.

2. A means for making a corrugated electrode core terminal interface, comprising:
(a.) means for spacing a plurality of termination wires along fold areas of a current collector foil;
(b .) means for wrapping the plurality of termination wires within the current collector foil;
(c.) means for folding the current collector foil along collector foil fold lines;
(d.) means for collecting the plurality of termination wires, whereby at least two groups of termination wires are thereby bundled together;
(e.) means for inserting the plurality of termination wires into at least one barrel termination, and;
(f.) means for crimping the barrel termination leads.

3. A method of making a corrugated electrode core terminal interface, comprising:
(a.) spacing a plurality of termination wires along fold areas of a first current collector foil;
(b.) operatively connecting each one of the plurality of termination wires to the first current collector foil member;
(c.) folding the first current collector foil along collector foil fold lines;
(d.) collecting the plurality of termination wires, and
(e.) forming the plurality of termination wires into at least one connector.

4. The method of claim 3 wherein the plurality of termination wires are spaced at equal intervals along the at least one current collector foil.

5. The method of claim 3 wherein the operatively connecting each one of the plurality of termination wires to the first current collector foil member comprises wrapping the termination wires within the first current collector foil.

6. The method of claim 5 wherein the termination wires are wrapped within the first current collector foil at the collector foil fold lines.

7. The method of claim 3 wherein the operatively connecting each one of the plurality of termination wires to the first current collector foil member comprises ultrasonically welding the termination wires to the first current collector foil.

8. The method of claim 3 wherein there is no overhang with respect to either the first current collector foil member, a separator element, or a second current collector foil member.

9. The method of claim 3 wherein the operation of collecting the plurality of termination wires comprises bundling together the plurality of termination wires into at least two groups of termination wires.

10. The method of claim 3 wherein the first current collector foil member comprises an activated element.

11. The method of claim 3 further comprising affixing the wires to leads.

12. The method of claim 11 wherein the affixing is by crimping.

13. The method of claim 3 wherein the connector is a barrel connector.

14. A corrugated electrode core terminal interface made by the method of claim 3.

15. An electric energy device comprising the corrugated electrode core terminal interface of claim 14.

16. An electric energy device of claim 15 selected from the group consisting of an ultracapacitor and a lithium ion battery.
